(19) United States
(12) Patent Application Publication
(10) Pub. No.: US 2013/0122309 A1
(43) Pub. Date: May 16, 2013

(54) POLYVINYLIDENE FLUORIDE DISPERSION

(71) Applicant: Arkema Inc., King of Prussia, PA (US)

(72) Inventors: Min Zheng, Berwyn, PA (US); Scott R. Gaboury, Blue Bell, PA (US)

(73) Assignee: Arkema Inc., King of Prussia, PA (US)

(21) Appl. No.: 13/629,841

(22) Filed: Sep. 28, 2012

Related U.S. Application Data
(60) Provisional application No. 61/559,342, filed on Nov. 14, 2011.

(51) Int. Cl. C09D 127/16; C08K 5/07; B32B 15/08; C08K 5/5317

(52) U.S. Cl. 428/421; 524/545; 524/520; 524/132; 524/360

(57) ABSTRACT

The invention relates to a polyvinylidene fluoride (PVDF) solvent dispersion composition containing PVDF (such as KYNAR 500) that is free of fluorosurfactants, an organic solvent, and low levels of dispersants. A pigmented version of this dispersion is also covered. The dispersion is useful for producing tough, chemical-resistant coatings, especially on metallic substrates, including for use as a coil coating or an architectural coating.

### REFERENCE TO RELATED APPLICATIONS

This application claims the benefit of U.S. Provisional Application Ser. No. 61/559,342, filed Nov. 14, 2011.

### FIELD OF THE INVENTION

The invention relates to a polyvinylidene fluoride (PVDF) solvent dispersion composition containing PVDF (such as KYNAR 500) that is free of fluorosurfactants, an organic solvent, and low levels of dispersants. A pigmented version of this dispersion is also covered. The dispersion is useful for producing tough, chemical-resistant coatings, especially on metallic substrates, including for use as a coil coating or an architectural coating.

### BACKGROUND OF THE INVENTION

Fluoropolymer dispersions are used to produce high performance coating. Among the fluoropolymers, polyvinylidene fluoride is especially preferred, as its solvency in common solvents allows for formulation into a stable solvent dispersion. PVDF dispersion coatings are especially favored for applications onto metal substrates, such as aluminum, hot dipped galvanized steel, and zinc-aluminum alloys on steel, where both excellent appearance and substrate protection must be maintained for a long period of time. Such PVDF dispersion coatings are useful in applications such as coil coating and architectural coatings, as described in U.S. Pat. No. 7,399,533.

Dispersants are commonly used to disperse pigments in a pigment grind. The pigment grind is then added to a polymeric dispersion to form a pigmented coating formulation. U.S. Pat. No. 8,022,117 lists many types of polymeric dispersants useful for dispersing pigments in a non-aqueous pigment dispersion. U.S. Pat. No. 6,017,639 describes the use of a few specific dispersants with a polyvinylidene fluoride synthesized using fluorosurfactants.

Fluorosurfactants in the form of perfluorinated or highly fluorinated surfactants are commonly used in the stabilization of fluoropolymer emulsions. For example, perfluorocarboxylate salts are used to stabilize fluoropolymer emulsion polymerizations, with the most common example being ammonium perfluorooctanoate. Fluorosurfactants are expensive, specialized materials, and because of their high stability they tend to persist in the environment and are under scrutiny from regulatory agencies. “Fluorinated surfactant” and “fluoro-surfactant” as used herein means that the main surfactant chain contains fluorine atoms whereas in the present invention non-fluorinated surfactants means that there is no fluorine on the main chain, however the terminal groups can contain fluorine atoms. “Fluorosurfactant-free” as used herein means that no fluorosurfactant was used in the synthesis or further processing of the fluoropolymer.

Applicant has developed new methods for the polymerization of stable fluoropolymer emulsions, without the use of fluorosurfactants. U.S. Pat. No. 6,869,997 describes the use of a 3-allyloxy-2-hydroxy-1-propanesulfonic acid salt as the surfactant in the preparation of a fluoropolymer. U.S. Pat. No. 6,841,616 describes the use of a siloxane, based surfactant as the surfactant in the preparation of a fluoropolymer. Other useful surfactants for use in a fluorosurfactant tree fluoropolymer include: polyvinylphosphonic acid, polyacrylic acid, polyvinyl sulfonic acid (US 2009-0221776); polyethylene glycol/polypropylene glycol block copolymers (US 2007-0135,546); alkyl phosphonates (2011-001665); and polycaprolactone (US 2011-0034632).

Applicant has now found that a more environmentally friendly fluorosurfactant-free fluoropolymer dispersion can be advantageously made using a low dispersant level in an organic solvent. The combination of the dispersant with the fluorosurfactant-free fluoropolymer, and especially a PVDF, produces a fluoropolymer dispersion having excellent processing properties. The dispersion of the invention is useful in high solids and low VOC coatings. Advantageously, the combination of a fluorosurfactant-free PVDF with a low level of dispersants synergistically results in a lower viscosity dispersion.

### SUMMARY OF THE INVENTION

The invention relates to a fluoropolymer dispersion composition comprising:
a) 25 to 90 weight percent of one or more fluoropolymers that are fluorosurfactant-free, based on the total fluoropolymer dispersion;
b) one or more solvents; and
c) from 0.02 to 5 weight percent of one or more dispersants, based on the weight of the fluoropolymer.

The invention further relates to a metallic substrate having a cured film layer to at least one surface, where the film composition is the residue of the fluoropolymer dispersion composition following curing.

### DETAILED DESCRIPTION OF THE INVENTION

All percentages used herein are weight percentages unless stated otherwise, and all molecular weights are weight average molecular weights unless stated otherwise. All references cited are incorporated herein by reference.

The term fluoropolymer denotes any polymer that has in its chain at least one monomer chosen from compounds containing a vinyl group capable of opening in order to be polymerized and that contains, directly attached to this vinyl group, at least one fluorine atom, at least one fluoroalkyl group or at least one fluoroalkoxy group. Examples of fluoromonomers include, but are not limited to vinyl fluoride; vinylidene fluoride (VDF); trifluoroethylene (VF3); chlorotrifluoroethylene (CTFE); 1,2-difluoroethylene; tetrafluoroethylene (TFE); hexafluoropropylene (HFP); perfluoro(alkyl vinyl)ethers, such as perfluoro(methyl vinyl)ether (PMVE), perfluoro(ethyl vinyl)ether (PEVE) and perfluoro(propyl vinyl)ether (PPVE); perfluoro(1,3-dioxole); perfluoro(2,2-dimethyl-1,3-dioxole) (PDD). Preferred fluoropolymers are the homopolymers and copolymers of vinylidene fluoride. An especially preferred fluoropolymer is a homopolymer of vinylidene fluoride.

The PVDF may be a homopolymer, a copolymer, a terpolymer or a blend of a PVDF homopolymer or copolymer with one or more other polymers that are compatible with the PVDF (co)polymer. PVDF copolymers and terpolymers of the invention are those in which vinylidene fluoride units comprise greater than 40 percent of the total weight of all the monomer units in the polymer, and more preferably, comprise greater than 70 percent of the total weight of the units. Copolymers, terpolymers and higher polymers of vinylidene fluoride may be made by reacting vinylidene fluoride with one or more monomers from the group consisting of vinyl fluoride, tritluoroethene, tetrafluoroethene, one or more of partly or fully fluorinated alpha-olefins such as 3,3,3-trifluoro-1-propene, 1,2,3,3,3-pentafluoropropene, 3,3,3,4,4-pentafluoro-1-butene, and hexafluoropropene, the partly fluorinated olefin hexafluoroisobutylene, perfluorinated vinyl ethers, such as perfluoromethyl vinyl ether, perfluoroethyl vinyl ether, perfluoro-n-propyl vinyl ether, and perfluoro-2-propoxypropyl vinyl ether, fluorinated dioxoles, such as perfluoro(1,3-dioxole) and perfluoro(2,2-dimethyl-1,3-dioxole), allylic, partly fluorinated allylic, or fluorinated allylic monomers, such as 2-hydroxyethyl allyl ether or 3-allyloxypropanediol, and ethene or propene.

The PVDF could also be grafted with a reactive monomer such as maleic anhydride, which can bond to surfaces and improve adhesion. These functionalized resins are described in U.S. Pat. No. 7,241,817, incorporated herein by reference.

The PVDF composition could also be a blend of a PVDF polymer with a compatible polymer, such as, but not limited to, an acrylic polymer or copolymer, such as polymethyl methacrylate (PMMA) or copolymers of MMA with C₁₋₄ acrylic monomers, where the PVDF makes up greater than 50 weight percent of the blend. A preferred embodiment is a blend of 70-98 weight percent of PVDF and 2-30 weight percent of polymethyl methacrylate or a polymethylmethacrylate copolymer. The PMMA copolymer contains more than 50 weight percent of methyl methacrylate monomer units. The acrylic polymer can be added to the PVDF polymer at an point during the formation of the final dispersion composition, and may be first blended with other components that are further blended with the PVDF. In one embodiment, a liquid premix containing the acrylic polymer in organic solvent(s) is first formed, and dispersing agents and the PVDF then added to the liquid premix.

The fluoropolymer of the invention is conveniently made by an emulsion polymerization process, but suspension and solution processes may also be used. In an emulsion polymerization process, a reactor is charged with de-ionized water, and a non-fluorinated water soluble surfactant capable of emulsifying the reactants and polymer during polymerization, and the reactor and its contents are deoxygenated while stirring. The reactor and contents are heated to the desired temperature and vinylidene fluoride, and, optionally, chain transfer agents to control copolymer molecular weight are added at the selected amount and ratio. When the desired reaction pressure is reached, an initiator is added to start and maintain the reaction.

The reactor used in the polymerization is a pressurized polymerization reactor, preferably a horizontal polymerization reaction, equipped with a stirrer and heat control means. The temperature of the polymerization can vary depending on the characteristics of the initiator used, but it is typically between 50° C. and 135° C., and most conveniently it is between 70° C. and 120° C. The temperature is not limited to this range, however, and might be higher or lower if a high-temperature or low-temperature initiator is used. The pressure of the polymerization is typically between 1380 and 8275 kPa, but it can be higher if the equipment permits operation at higher pressure. The pressure is most conveniently between 3450 and 5520 kPa.

Non-fluorinated emulsifiers suitable for use in this invention include, but are not limited to:
i) non-ionic block copolymers with formula of

T₁-[(CH₂—CH₂—O—)_{X}]ₘ—[(CH₂—C(CH₃)—O—)_{Y}]ₙ—[(CH₂—CH₂—CH₂—CH₂—O—)_{Z}]ₖ-T₂
wherein, X, Y, and Z are between 2 to 200; and m, n, k are from 0 to 5, T₁ and T₂ are terminal groups selected from hydrogen, hydroxyl, carboxyl, ester, ether and/or hydrocarbon;
ii) alkyl phosphonic acids, polyvinylphosphonic acid, polyacrylic acid, polyvinyl sulfonic acid, and the salts thereof;
iii) alkanesulfonate selected from C7-C20 linear 1-alkanesulfonates, C7-C20 linear 2-alkanesulfonates, C7-C20 linear 1,2-alkanedisulfonates, and mixtures thereof
iv) alkyl sulfate surfactants such as R—SO₄M, and MO₄S—R—SO₄M; where R is a hydrocarbon group, and M is a monovalent cation selected. Examples are sodium laurel sulfate, potassium laurel sulfate, ammonium laurel sulfate, and mixtures thereof.

The surfactant charge is from 0.05% to 5% by weight on the total monomer weight used, and most preferably the surfactant charge is from 0.1% to 2% by weight.

A paraffin antifoulant may be employed, if desired, although it is not preferred, and any long-chain, saturated, hydrocarbon wax or oil may be used. Reactor loadings of the paraffin may be from 0.01% to 0.3% by weight on the total monomer weight used.

The reaction can be started and maintained by the addition of any suitable initiator known for the polymerization of fluorinated monomers including inorganic peroxides, “redox” combinations of oxidizing and reducing agents, and organic peroxides. A preferred initiator is peroxydisuifate.

The total amount of initiator used is generally from 0.05% to 2.5% by weight based on the total monomer weight used. Typically, sufficient initiator is added at the beginning to start the reaction and then additional initiator may be optionally added to maintain the polymerization at a convenient rate.

As the reaction progresses, additional monomer, initiator, and optionally chain transfer agent are fed to maintain reaction pressure. Following completion of the monomer feed the reaction is continued for a short time, about 10 to 20 minutes, then the reactor is cooled as quickly as possible. After reaching ambient temperatures, the unreacted monomers are vented and the latex produced by the reaction is drained.

The fluoropolymer dispersion of the invention has a solids level of from 15 to 70 weight percent, preferably from 20 to 65 weight percent. The fluoropolymer particles in the dispersion have a particle size in the range of 50 to 1000 nm, and preferably from 100-500 nm. The fluoropolymer has a weight average molecular weight of from 100,000 to 2,000,000, and preferably from 300,000 to 1,000,000 g/mol.

To obtain dry resin, the latex is coagulated by conventional methods the coagulum is separated and the separated coagulum may be washed. To provide powder, the coagulum is dried by means known in the art, such as by spray drying or freeze drying.

The fluorosurfactant-free fluoropolymer is present in the fluoropolymer dispersion at from 25 to 90 weight percent, preferably from 30 to 75 weight percent.

The fluorosurfactant-free fluoropolymer is dispersed in an organic solvent using a low level of one or more dispersants, and optional additives to form the dispersion composition. The level of dispersant used is from 0.02 to 5%, based on the weight of fluoropolymer, and preferably from 0.1 to 3% by weight.

Preferred dispersants are phosphonic acids (and salts thereof), and some natural polymers or synthetic polymers. Polymeric dispersants may have different polymer architectures including linear, comb/branched, star, dendritic (including dendrimers and hyperbranched polymers.

Useful natural polymers include, but are not limited to proteins, such as glue, gelatine, casein, and albumin; naturally occurring rubbers, such as gum arabic and tragacanth; glucosides such as saponin; alginic acid and alginic acid derivatives, such as propylene glycol alginate; and cellulose derivatives, such as methyl cellulose, carboxymethyl cellulose and ethylhydroxy cellulose; wool and silk, and synthetic polymers.

Useful synthetic dispersants include, but are not limited to phenylphosphonic acid, modified polyurethanes (such as TEXAPHOR P63 from BASF), polyester/polyamine condensates (such as SOLSPERSE 28000, 36600 and 24000SC from Lubrizol, Inc), alkylol ammonium salts of acidic polyesters (such as DISPERBYK-180 from BYK-Chemie), salts of unsaturated polyamine amides and higher molecular weight acidic esters (such as ANTITERRA U 80 from BYK Chemie, or DISPERBYK W966 from BYK Chemie), salts of long chain polyamine amides and polar acidic esters (such as DISPERBYK 101 from BYK Chemie), partial amides of higher molecular weight unsaturated polycarboxylic acids (such as DISPERPLAST I from BYK Chemie), high molecular weight polyester/polyurethane block copolymers (such as DISPERBYK 163 and DISPERBYK 167 from BYK Chemie, NUOSPERSE 9850 from Elementis Specialties), partially fluorinated acrylic copolymers (such as Capstone FS22 from DuPont), fluoroaliphatic polymeric esters (such as NOVEC FC4430 from 3M) and fluorinated anionic surfactants. All of above dispersants can be used as supplied except the Phenylphosphonic acid which is preferred to dissolve in ethanol at 10-20 wt % before incorporated into the fluoropolymer dispersion.

The fluorosurfactant-free fluoropolymer, and dispersant are dispersed in an organic solvent, or a mixture of organic solvents. The organic solvent typically acts as a latent solvent for the fluoropolymer; that is, the fluoropolymer is substantially insoluble and dispersed in the solvent at room temperature but becomes solvated or dissolved in the solvent when the composition is heated. The solvent generally makes up 1 to 50 weight percent and, preferably, about 25 to about 40 weight percent of the composition. Where the composition includes substantial amounts of a ketone solvent, such as isophorone, a smaller amount of a non-aromatic ester, e.g., about 5 to about 20 weight percent, may be employed as well. In one embodiment of the invention, the solvent component of the composition preferably includes a majority of a non-aromatic ester.

In some instances, it may be preferable to choose a solvent that will not be totally volatilized under the baking conditions used and the residual solvent remaining in the film can act as a plasticizer. For other applications, it may be preferable to choose a solvent that will be essentially completely volatilized under the baking conditions employed. Preferably the solvent has a boiling point of from 170° C. to 400° C.

Solvents useful in the invention include, but are not limited to, glycerol esters, glycol esters, esters (e.g., butyrates) of other aliphatic polyols, phthalates, adipates, benzoates, azelates, carbonates, trimellitates, phosphates, citrates, stearates, sebacates, glutarates, oleates, alkyds, polymeric esters, epoxidized oils, epoxy tallates, amide-esters, sulfonamides, terpenes, aromatics and ketones, esters of aliphatic dibasic acids and di- or triesters of aliphatic polyols and monoesters of alkyleneoxy ethers. Preferably the solvent includes a diester of a branched aliphatic diol, and more preferably, a butyrate diester of a branched octanediol, such as 2,2,4-trimethyl-1,3-pentanediol diisobutyrate (“TXIB”).

Other preferred solvents for use in the present invention include polyol diesters, such as triethylene glycol bis(2-ethylhexanoate) (TEG-EH), and esterfied ethers, e.g., esters of glycol monoethers such as propyleneglycol methyl ether acetate (PMAacetate) or dipropyleneglycol methyl ester acetate (DPMA)

Other useful solvents which may be present to some extent as part of the solvent portion of the present compositions include phthalates such as butyl benzyl phthalate and dialkyl phthalates (e.g., di(2-ethylhexyl) phthalate, dimethyl phthalate and dioctyl phthalate); aromatics such as toluene and xylenes; ketones such as isophorone; aliphatic dibasic acid esters such as dioctyl azelate, diisodecyl adipate and di(2-ethylhexyl) sebacate; phosphates such as trioctyl phosphate and 2-ethylhexyl diphenyl phosphate; epoxy plasticizers such as epoxidized soybean oil, epoxidized tall oil fatty acid 2-ethylhexyl esters, and other conventional polyester solvents commonly employed as plasticizers.

Preferably, at least about 60 weight percent of the solvent portion of pigmented versions of the present composition consists of one or more non-aromatic esters. The solvent fraction may include a minor amount (i.e., no more than about 30 weight %) of a non-aromatic ketone and/or a hydroxy functional solvent such as a glycol monoether (e.g., butyl carbitol) or a half ester of an aliphatic diol (e.g., 2,2,4-trimethyl-1,3-pentanediol monoisobutyrate). More preferably, at least about 90 weight % and, most preferably, substantially all of the solvent portion consists of one or more non-aromatic esters. In one embodiment at least 95 weight percent of the solvent portion is 2,2,4-trimethyl-1,3-pentanediol diisobutyrate (TXIB). Other preferred compositions include a solvent component consisting essentially of TXIB, butyl carbitol acetate, PM acetate, DPM acetate or mixtures thereof.

In designing a particular formulation, the dispersant and solvent system are typically chosen to complement each other. For example, amine-based dispersants are particularly effective where the main solvent is an ester or mixture of esters. When the coating composition is based on a ketone solvent, fluorinated anionic surfactants can be particularly effective.

One or more other additives may also be added to form a final dispersion coating composition. Such additives are known in the coating art, and include a flatting agent to reduce gloss, an additive to improve mar resistance, surfactants, antioxidants, ultraviolet light absorbers and stabilizers, rheology control agents, coalescing agents and the like.

The present compositions may be a clear (unpigmented), such as when applied as a protective top coat layer. The coating composition is often pigmented to provide opacity, and color. Typical, pigmented versions of the present composition include about 5 to about 50 and preferably about 20 to about 40 weight % of one or more pigments. Useful pigments include pigments generally used in the coating industry,

The coating composition of the present invention may be prepared by conventional methods. For example, the coating composition may be prepared by blending the various components using a high speed disperser and milling equipment, such as a small media mill.

The dispersion coatings of the invention may be applied to a substrate by means known in the art, including but not limited to brushing, bar coating, roll coating, inkjet application and spraying. The coating may be applied to one, or more sides of the substrate. The substrate is generally metallic, including but not limited to aluminum, hot dipped galvanized steel, and zinc-aluminum alloys on steel. Two or more coats of the dispersion coating may be added, and the metal may be physically or chemically primed prior o coating. Following application of the fluoropolymer dispersion coating the substrate is heated to cure the coating and form a tough film.

Where large rolls of thin gauge metal are to be coated, it is advantageous to apply the coating composition via a coil coating process, such as reverse roll coating. When the coating is carried out using such a process, the coated metal substrate is typically cured by heating for about 10 to about 50 seconds at a temperature of about 200° C. to 300° C. If a spray coating process is used the resulting film is usually cured by heating for about 10 to about 15 minutes at a temperature of about 210° C. to about 270° C. The baking temperatures are not critical, but must be high enough to cause the fluoropolymer particles in the dispersion to coalesce into a continuous film.

The coating composition of the invention is generally used at a total solids content of from 30 to 70 weight percent. If desired, however, the composition may be thinned prior to being applied by the addition of a solvent. For spray applications additional solvent, such as xylene, toluene, methyl ethyl ketone or 2-butoxy ethanol, or the like, may be added to reduce the resin solids content of the composition. The useful viscosity of the dispersion varies depending upon the spray equipment and atmospheric conditions. When applied via spray methods, pigmented versions of the present composition typically have a viscosity of 20-60 (#2 Zahn) and a total solids content of about 50 to about 70 weight percent (total resin solids of about 35 to about 50 weight percent). Clear versions of the present coating composition generally have a similar viscosity and contain a total resin solids content of about 30 to about 45 weight %.

The composition of the invention has a reduced dispersion viscosity compared to PVDF dispersions in organic solvents without the presence of the low levels of dispersants. This can bring advantages in increasing the PVDF resin solid content and thus reduce the dispersion VOC level.

### EXAMPLES

The following examples are intended to illustrate further various aspects of the present invention, but are not intended to limit the scope of the invention in any aspect.

### Raw Materials:

PVDF: Polyvinylidene fluoride, available from Arkema Inc. as KYNAR 500;
PARALOID AU 1033: Methyl methacrylate-ethyl acrylate copolymer, available from Dow Chemicals.
TI-PURE R960 TiO₂, available from DuPont

Dispersing Agents:

| Dispersing Agents | Manufacturer/Supplier | active % | Chemistry |
|---|---|---|---|
| PHENYLPHOSPHONIC ACID | Sigma-Aldrich | 100 | Phosphonic acid |
| NUOSPERSE 15 | Elementis Specialites | 65 | Amine free polymeric dispersing agent |
| NUOSPERSE 9850 | Elementis Specialites | 45 | high Mw polyester/polyurethane block copolymer |
| TEXAPHOR P63 | Cognis/BASF | 45 | modified polyurethane |
| K-SPERSE A503 | King Industries | 40 | Amine free polymeric dispersing agent |
| DISPERBYK 101 | BYK Chemie | 50 | salt of long chain polyamine amides and a polar acidic ester |
| DISPERBYK W966 | BYK Chemie | 50 | salt of unsaturated polyamine amides and acidic polyesters |
| DISPERBYK 163 | BYK Chemie | 45 | high Mw polyester/polyurethane block copolymer |
| DISPERBYK 167 | BYK Chemie | 52 | high Mw polyester/polyurethane block copolymer |
| SOLSPERSE 36600 | Lubrizol | 40 | polyester/polyamine condensates |
| SOLSPERSE 28000 | Lubrizol | 100 | polyester/polyamine condensates |
| SOLSPERSE 24000SC | Lubrizol | 100 | polyester/polyamine condensates |
| CAPSTONE FS22 | DuPont | 30 | partically fluorinated acrylic copolymer |

Formulations and Test Methods:

The tested formulations of PVDF resin dispersions and the white finished paints are shown below. The dispersion viscosities of both resin pastes and white paints were measured with Stormer viscometer and Brookfield Viscometer.

liquid premix

| | |
|---|---|
| Au1033 Acrylic resin (50%) | 356 |
| Isophorone | 480 |
| Cyclohexanone | 480 |
| Texanol | 480 |
| Tolal | 1796 |

Resin Dispersion

| | | |
|---|---|---|
| PVDF resin | 119.6 | Grind at 3700 rpm for |
| liquid premix | 134.4 | 10 minutes at 30 C. |
| Dispersing Agents, active | 1.2 | |
| Total | 255.2 | |

Pigment Dispersion

| | | |
|---|---|---|
| Au1033 (50%) | 505 | Grind at 3700 rpm for |
| R960 TiO2 pigment | 616 | 30 minutes |
| Isophorone | 78 | |
| Cyclohexanone | 78 | |
| Texanol | 78 | |
| Total | 1355 | |

Finished paint

| | |
|---|---|
| PVDF resin dispersion | 113 |
| pigment dispersion | 90.3 |
| Isophorone | 15 |
| Cyclohexanone | 15 |
| Texanol | 15 |
| Total | 248.3 |

### 1) Preparation PVDF Resin Grind (Clear Coat)

119.6 g of PVDF resin was slowly added to the blend of 1.2 g active dispersing agents and 134.4 g liquid premix composed of 19.8% of PARALOID Au1033 acrylic resin (50%) solution in Toluene, 26.7% of Isophorone, 26.7% of Cyclohexanone and 26.7% of TEXANOL under agitation in a jacketed grind pot supplied with coolant from the chilled water system. The grinds were performed in a hood using an air-driven Cowles grind apparatus for 10 minutes at 3700 rpm and 30° C.

### 2) Preparation of White Pigment Grind

616 g of R960 TiO2 powders were slowly added to 739 g of blend of 68.3% of PARALOID Au1033 (50%) solution in Toluene, 10.6% of Isophorone, 10.6% of Cyclohexanone and 10.6% of TEXANOL under agitation. The grind was performed in a hood using an air-driven Cowles grind apparatus for 30 minutes at 3700 rpm.

### 3) Finished Pigmented Paint

113 g of above resin grind, 90.3 g of above pigment grind and 45 g of solvent blends of Isophorone, Cyclohexanone and TEXANOL at equivalent ratios were blended and shaken 30 minutes with a paint shaker.

As seen from the results of working examples and comparative examples, the incorporation of a small amount of these dispersing agents brought in a significant reduction of the viscosity (Stormer and Brookfield) and Thixotropic Index of FSF KYANR PVDF dispersion in organic solvents. These dispersing agents also reduce the viscosity of PVDF white paints.

| | | PVDF Resin Dispersions | | | | | |
|---|---|---|---|---|---|---|---|
| | | | | | | | Thixotropic |
| | | | | | | | Index |
| | | Stormer | Brookfield Viscosity (cP) | | | | viscosity at 5 |
| | | Viscosity | 0.5 | 5 | 50 | 100 | rpm/viscosity |
| Comparative | | (KU) | rpm | rpm | rpm | rpm | at 50 rpm |
| Examples | Control w/o dispersants | 96 | 63120 | 10936 | 1672 | 1050 | 6.5 |
| Working | PHENYLPHOSPHONIC ACID | 75 | 14328 | 2743 | 790 | 596 | 3.5 |
| Examples | NUOSPERSE 15 | 76 | 37760 | 6080 | 1235 | 813 | 4.9 |
| | NUOSPERSE 9850 | 74 | 27200 | 4656 | 1102 | 786 | 4.2 |
| | TEXAPHOR P63 | 90 | 57600 | 9028 | 1675 | 973 | 5.4 |
| | K-SPERSE A503 | 75 | 31360 | 5184 | 1094 | 733 | 4.7 |
| | DISPERBYK 101 | 74 | 11520 | 2560 | 787 | 589 | 3.3 |
| | DISPERBYK W966 | 73 | 14720 | 2944 | 800 | 589 | 3.7 |
| | DISPERBYK 163 | 87 | 54789 | 8765 | 1654 | 934 | 5.3 |
| | DISPERBYK 167 | 90 | 58640 | 9120 | 1754 | 1066 | 5.2 |
| | SOLSPERSE 36600 | 80 | 29440 | 5184 | 1190 | 832 | 4.4 |
| | SOLSPERSE 28000 | 84 | 36480 | 6272 | 1421 | 1184 | 4.4 |
| | SOLSPERSE 24000SC | 78 | 30080 | 5184 | 979 | 816 | 5.3 |
| | CAPSTONE FS22 | 82 | 48640 | 7744 | 1561 | 1030 | 5.0 |

| | | White Finished Paints | | | | | |
|---|---|---|---|---|---|---|---|
| | | | | | | | Index |
| | | Stormer | Brookfield Viscosity (cP) | | | | viscosity at 5 |
| | | Viscosity | 0.5 | 5 | 50 | 100 | rpm/viscosity |
| Comparative | | (KU) | rpm | rpm | rpm | rpm | at 50 rpm |
| Example | Control w/o dispersants | 88 | 69120 | 9088 | 1395 | 867 | 6.5 |
| Working | PHENYLPHOSPHONIC ACID | 70 | 10530 | 2056 | 580 | 485 | 3.5 |
| Examples | NUOSPERSE 9850 | 73 | 13440 | 2496 | 672 | 531 | 3.7 |
| | TEXAPHOR P63 | 73 | 19200 | 3008 | 704 | 534 | 4.3 |
| | K-SPERSE A503 | 80 | 15360 | 3328 | 928 | 755 | 3.6 |
| | DISPERBYK 101 | 80 | 36480 | 5376 | 1139 | 822 | 4.7 |
| | DISPERBYK W966 | 76 | 18560 | 3392 | 870 | 659 | 3.9 |
| | DISPERBYK 163 | 72 | 28670 | 4012 | 858 | 612 | 4.7 |
| | DISPERBYK 167 | 74 | 30080 | 4480 | 864 | 608 | 5.2 |
| | SOLSPERSE 36600 | 83 | 56960 | 8576 | 1433 | 1018 | 6.0 |
| | SOLSPERSE 28000 | 74 | 36480 | 5312 | 922 | 630 | 5.8 |
| | SOLSPERSE 24000SC | 74 | 35840 | 5440 | 966 | 666 | 5.6 |
| | CAPSTONE FS22 | 71 | 23680 | 6912 | 1421 | 749 | 4.9 |

What is claimed is:

1. A fluoropolymer dispersion composition comprising:
d) 25 to 90 weight percent of one or more fluoropolymers that are fluorosurfactant-free, based on the total fluoropolymer dispersion;
e) one or more solvents; and
f) from 0.02 to 5 weight percent of one or more dispersants, based on the weight of the fluoropolymer.

2. The fluoropolymer dispersion of claim 1, wherein said fluoropolymer is a polyvinylidene fluoride (PVDF) homopolymer or copolymer.

3. The fluoropolymer dispersion of claim 1, wherein said fluoropolymer is a polyvinylidene fluoride homopolymer.

4. The fluoropolymer dispersion of claim 1, wherein said dispersion further comprises from 2 to 30 weight percent of a polymer compatible with said fluoropolymer.

5. The fluoropolymer dispersion of claim 4, wherein said compatible polymer is an acrylic polymer containing from greater than 50 to 100 weight percent of methyl methacrylate units.

6. The fluoropolymer dispersion of claim 1, comprising from 30 to 75 weight percent of one or more fluorosurfactant-free fluoropolymers, based on the total fluoropolymer dispersion.

7. The fluoropolymer dispersion of claim 1, comprising from 0.1 to 3 weight percent of one or more dispersants, based on the weigh of said fluoropolymer.

8. The fluoropolymer dispersion of claim 1, wherein said dispersant comprises one or more dispersants selected from the group consisting of phosphonic acids, oxyalkylated amities, oxyalkylated alkyl amines, modified polyurethanes, polyester/polyamine condensates, alkylol ammonium salts of acidic polyesters, salts of unsaturated polyamine amides and higher molecular weight acidic esters, salts of long chain polyamine amides and polar acidic esters partial amides of higher molecular weight unsaturated polycarboxylic acids, high molecular weight polyester/polyurethane block copolymers, partially fluorinated acrylic copolymers, and fluorinated anionic surfactants.

9. The fluoropolymer dispersion of claim 1, wherein said solvent(s) comprises from 1 to 50 weight percent of the total dispersion composition, and are elected from the group consisting of glycerol esters, glycol esters, esters of aliphatic polyols, phthalates, adipates, benzoates, azelates, carbonates, trimellitates, phosphates, citrates, stearates, sebacates, glutarates, oleates, alkyds, polymeric esters, epoxidized oils, epoxy tallates, amide-esters, sulfonamides, terpenes, aromatics and ketones, esters of aliphatic dibasic acids and di- or triesters of aliphatic polyols and monoesters of alkyleneoxy ethers, a diester of a branched aliphatic diol, a butyrate diester of a branched octanediol, 2,2,4-trimethyl-1,3-pentanediol diisobutyrate, polyol diesters, triethylene glycol bis(2-ethylhexanoate), esterfied ethers, esters of glycol monoethers, propyleneglycol methyl ether acetate, and dipropyleneglycol methyl ester acetate, phthalates, butyl benzyl phthalate, dialkyl phthalate, dimethyl phthalate, dioctyl phthalate, aromatics, toluene, xylenes, ketones, isophorone, aliphatic dibasic acid esters, dioctyl azelate, diisodecyl adipate, di(2-ethylhexyl) sebacate; phosphates, trioctyl phosphate, 2-ethylhexyl diphenyl phosphate, epoxidized soybean oil, epoxidized tall oil fatty acid 2-ethylhexyl esters, and mixtures thereof.

10. The fluoropolymer dispersion of claim 1, wherein said dispersion further comprises 5 to 50 weight percent of one or more inorganic pigments, based on the total weight of the dispersion.

11. A coated metallic substrate wherein at least one surface comprises a cured film layer adhered to said metallic substrate, wherein said cured film comprises the residue of said fluoropolymer dispersion of claim 1.
